(19) United States
(12) Patent Application Publication
(10) Pub. No.: US 2020/0173697 A1
(43) Pub. Date: Jun. 4, 2020

(54) Apparatus And Method For Thermoelectric Cooling Of Comestible Products

(71) Applicant: Jeffrey D. Resnick, Superior, CO (US)

(72) Inventor: Jeffrey D. Resnick, Superior, CO (US)

(21) Appl. No.: 16/208,769

(22) Filed: Dec. 4, 2018

(51) Int. Cl. F25B 21/02; A23G 9/22; A23G 9/28

(52) U.S. Cl. CPC F25B 21/02; A23G 9/281; A23G 9/222

(57) ABSTRACT

Disclosed herein are methods, systems, and apparatuses for dispensing comestible products that are frozen or partially frozen by thermoelectric cooling. The systems and apparatuses may function for long periods of time without cleaning. The systems and apparatuses may be used in producing soft-serve and frozen beverage products including soft-serve ice cream, frozen yogurt, smoothies, acai mix, and other foods capable of being made into soft-serve products, and frozen beverages, slush, margaritas, granita, and the like. One or more thermoelectric cooling elements may be used to quickly and efficient freeze-down small batches of product. A lateral extrusion mechanism may be used to effect movement of the thermoelectric cooling element toward and away from the product. When the product is contained within a deformable container, a vertical extrusion mechanism may be used to effect dispensing of the product from the container into a desired receptacle.

### TECHNICAL FIELD

Described herein are methods and systems for thermoelectrically cooling comestible products (e.g., smoothie, acai mix, soft-serve ice cream, frozen yogurt, frozen beverages, or other similar items) and dispensing the comestible products as frozen comestible products.

### BACKGROUND

The information included in this Background section of the specification, including any references cited herein and any description or discussion thereof, is included for technical reference purposes only and is not to be regarded subject matter by which the scope of the invention as defined in the claims is to be bound.

Conventional refrigeration systems used in soft serve and frozen beverage machines or batch freezers (e.g., for freezing and dispensing smoothies, soft-serve ice cream, frozen yogurt, frozen beverages, and the like) require various large and expensive components, such as compressors, condensers, copper or other refrigeration lines, refrigerants such as Freon, expansion valves, a gear reducer, start-stop components, and a large motor. Many of these components (e.g., the bulky compressor) cannot be shipped via airplane or express. These machines or freezers typically have a large footprint up to about 35 cubic feet, a weight of up to 600 pounds, and can cost up to about $25,500. In addition, current freeze down time is typically from about 5 to about 15 minutes for conventional soft serve and barrel frozen beverage machines or batch freezers, and over 30 minutes for frozen beverage or granita machines with a plastic bowl. Further yet, these machines or freezers require routine cleaning and maintenance of the various components, which takes time (generally 20 minutes to 1 hour), is prone to operational error during assembly, and presents significant health risks due to the nature of the equipment. Finally, conventional machines or freezers are generally inefficient and are required to be constantly running to keep the product at the desired temperature and consistency for eventual dispensing, since current freeze down times do not allow for quick startup and dispensing of single batches or the like. Currently-available soft serve and frozen beverage machines or batch freezers are bulky, costly, inefficient, and are not suitable for rapid freeze down times or single-batch servings of product. Rather, such machines require loading of product into the machine at the product's desired dispensing temperature, which requires costly transport and storing of the product at low temperatures.

The size, cost, and inefficiency of currently-available soft serve and frozen beverage machines or batch freezers has made it a challenge to offer systems capable of rapid freeze down times and of single-batch servings of product. A machine capable of providing such rapid freeze down times and single-batch servings of product, particularly from a relatively warm (e.g., room temperature) base material, is currently unavailable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

As used herein, a “frozen” product may refer to a product that is completely or partially in the solid state of matter as a result of a decrease in temperature. As used herein, a “frozen” product may be predominantly solid but may be partially (e.g., have components in) liquid or gas states. As one skilled in the art will appreciate, temperature, composition (i.e., ingredients), and pressure may affect the solidness of a frozen product.

The present disclosure is generally related to an apparatus and method for dispensing a comestible product, such as a frozen comestible product. In some particular embodiments, the comestible product may be dairy or non-dairy soft-serve ice cream or frozen yogurt, shake, smoothie, acai mix, frozen beverage (carbonated or non-carbonated and alcoholic or non-alcoholic), or frozen edible product.

An apparatus embodying the present disclosure may have a cooling chamber for receiving a deformable container within which the comestible product is stored, as well as a product conduit. The comestible product may be received in, for example, the product conduit of the apparatus. The product conduit may have an upper (or first) end and a terminal (or second) end. The apparatus may further include one or more thermoelectric cooling elements for cooling the comestible product (e.g., cooling the product to frozen or to a desired temperature for dispensing). For example, the one or more thermoelectric cooling elements may be capable of cooling the cooling chamber to 0 degrees Fahrenheit or less within 20 seconds of starting the apparatus. Relatedly, the one or more thermoelectric cooling elements may be capable of cooling the comestible product (or, more preferably, the container in which the comestible product is stored) to 24 degrees Fahrenheit or less within 60 seconds of starting the apparatus. In other embodiments, such as when the product to be dispensed is a frozen beverage product, the product may be cooled by the one or more thermoelectric cooling elements to a greater temperature depending on factors such as gas, brix, and the like, although the frozen beverage product may generally be cooled to a temperature of 32 degrees Fahrenheit or less within 60 seconds of starting the apparatus. The comestible product may be a shelf-stable product. The comestible product may be stored and/or introduced into the dispensing apparatus at a refrigerated temperature or at room temperature. For example, in some embodiments, the comestible product may be stored and introduced into the dispensing apparatus at a temperature of 50 degrees Fahrenheit or more, such as room temperature.

An extrusion mechanism may be provided in the apparatus for effecting dispensing of the comestible product through the product conduit to an outlet at the terminal end of the product conduit. In alternative embodiments, the comestible product may be extruded directly from the container and dispensed directly into a desired receptacle (e.g., a cone, cup, or dish).

The extrusion member may be a vertical extrusion mechanism such as, for example, a plunger or roller. The vertical extrusion member may compress the deformable container, thereby reducing the volume of the deformable container and extruding the comestible product under increased pressure through the product conduit to an outlet at the terminal end of the product conduit.

Alternatively, or in addition to, a vertical extrusion mechanism, a lateral extrusion mechanism, such as, for example, a spring or plunger, may be included in the apparatus. The lateral extrusion mechanism may effect movement (e.g., reciprocal linear movement) of the one or more thermoelectric cooling elements toward and/or away from the product conduit. More specifically, the lateral extrusion mechanism may contact and effect movement of the at least one thermoelectric cooling element toward and away from the product conduit, such that the thermoelectric cooling contacts and at least partially compresses the deformable container, thereby reducing the volume of the deformable container and extruding the comestible product under increased pressure through the product conduit to an outlet at the terminal end of the product conduit. In alternative embodiments, the dispensing apparatus may be devoid of an extrusion mechanism and the deformable container may be designed such that a user may consume the comestible product directly therefrom after cooling of the product, such as through an opening in the pouch adapted to receive a straw therethrough or, alternatively, through an opening through which the user may squeeze or otherwise extrude the product by hand.

In certain disclosed embodiments, first and second thermoelectric cooling elements may be spaced apart from one another (such as along opposing sides of the cooling chamber) so as to form a product conduit therebetween. In particular embodiments, each of the first and second thermoelectric cooling elements may have a semicircular cross-section so as to form a circular product conduit therebetween. In alternative embodiments, the product conduit may be spherical, such that the product is dispensed through the bottom of the spherical product conduit.

The comestible product may be contained within a deformable container, which may be hermetically sealed and/or aseptic and include a nozzle or the like through which the comestible product is dispensed from the deformable container. The terminal end of the product conduit may or may not be located within the cooling chamber and may include a nozzle or the like for effective dispensing of the comestible product into a desired receptacle (e.g., a cone, cup, or dish). The deformable container may be disposable and contain a single serving of the comestible product. In alternative embodiments, the dispensing apparatus may be adapted to store any desirable number of containers or amount of product. The dispensing apparatus may be configured to automatically refill empty container as necessary, so as to automate the dispensing process and further reduce necessary cleaning, maintenance, and the complexity of the user interface. When multiple containers are desired to be stored for dispensing, the containers may include an assortments of products and/or flavors, such that a user has a variety of options from which to choose. The dispensing apparatus may include a user interface adapted to permit the user to selectively choose a particular product and/or flavor, such that the dispensing apparatus cools and dispenses product from the chosen container and then discards the container into a trash, recycling, or cleaning receptacle within the dispensing apparatus.

The apparatus may also include one or more heat sinks. When one or more heat sinks are provided, each thermoelectric cooling element may be positioned such that it is between one of the heat sinks and the product conduit. As will be appreciated by those skilled in the art, any desired number or combination of thermoelectric cooling elements and heat sinks may be used for a desired application and to achieve a desired result (e.g., a particular temperature for the cooling chamber depending on volume and composition of the comestible product).

The disclosed dispensing apparatus may have a relatively small footprint compared to conventional soft serve and frozen beverage machines or batch freezers. For example, the disclosed dispensing apparatus may have a total weight of 35 pounds or less, including, in some embodiments, a total weight of 10 pounds or less. The disclosed dispensing apparatus may also have a total volume of 3 cubic feet or less, including, in some embodiments, a total volume of less than 1 cubic foot. The disclosed dispensing apparatus may also not include costly and heavy components typically found in conventional soft serve and frozen beverage machines or batch freezers. For example, the disclosed dispensing apparatus may not include a compressor or condenser. Similarly, the disclosed dispensing apparatus may not require the use of refrigerant lines or refrigerants such as Freon. Similarly, due to the possibility of offering single-servings using the disclosed dispensing apparatus, the disclosed dispensing apparatus may not require large motors or mechanisms typically needed to transport frozen product in large holding containers (e.g., generally at least 38 ounces, including over 80 ounces for commercial soft serve machines and over 128 ounces for commercial frozen beverage machines).

The cooling chamber of the apparatus may include an agitator (e.g., driven by a motor) for mixing the comestible product within the cooling chamber. The one or more thermoelectric cooling elements may chill the cooling chamber, and the agitator may be used to remove frozen or partially frozen product from the walls of the cooling chamber.

Dispensing of the comestible product from the apparatus may be selectively controllable by a user of the apparatus. Selectively controllable dispensing may be effected by, for example, the use of one or more valves that selectivity control the flow of the comestible product through the product conduit and out of the outlet.

The disclosed apparatus, methods, and systems may be able to dispense comestible product for long periods of time without the need to clean and/or disinfect the system. The extended cleaning cycle may be possible because the disclosed system may be sealed-off from ambient air, particularly where the principal components are aseptic and are added to the system aseptically. As previously described, the deformable container may be disposable and contain only a single serving of comestible product. In this regard, the deformable container may be sealed, such that the comestible product is dispensed directly therefrom without unnecessary direct contact with the cooling chamber, thereby obviating the need to sanitize or clean the cooling chamber after each use. The deformable contained may then be discarded after each use. In many cases, the system can be safely operated for ten days without cleaning. Frequently, an embodiment of systems described herein may be safely operated for several months without cleaning. In particular embodiments, the system may be safely operated for about 90 to about 120 days without cleaning. In other embodiments, the system may even be safely operated for six months without cleaning.

The disclosed apparatus, methods, and systems may be able to dispense a comestible product in such a way that differs from currently available products, namely by being capable of rapid freeze down times and freezing and dispensing of pre-packaged, shelf-stable, and/or single-batch servings of product using thermoelectric cooling.

### BRIEF DESCRIPTION OF THE DRAWINGS

The foregoing and other features of the present disclosure will become more fully apparent from the following description, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

In the drawings:

FIG. 1 is a perspective view of one embodiment of the disclosed dispensing apparatus in combination with a base and tray;

FIG. 2 is a perspective view of one embodiment of a cooling chamber of the disclosed dispensing apparatus;

FIG. 3 is a front view of the cooling chamber of FIG. 2;

FIG. 4 is a front view of one embodiment of a deformable container for use with the disclosed dispensing apparatus;

FIG. 5 is a side view of the deformable container of FIG. 4;

FIG. 6A is a front view of an alternative embodiment of a spherical cooling chamber of the disclosed dispensing apparatus; and

FIG. 6B is a side view of an alternative embodiment of a cylindrical cooling chamber of the disclosed dispensing apparatus.

### DETAILED DESCRIPTION

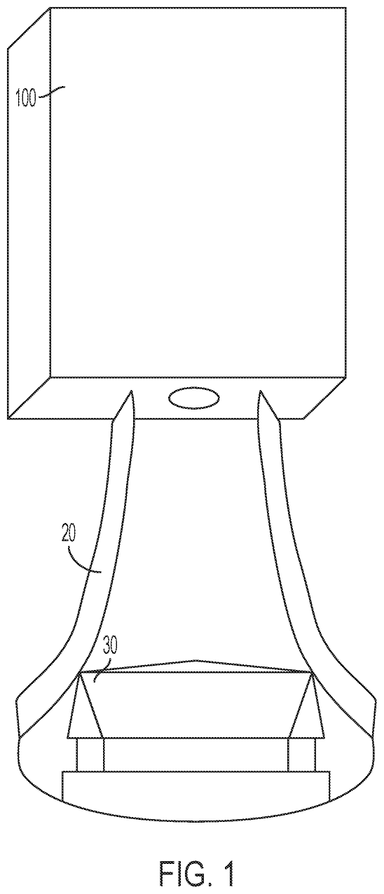

With reference to FIGS. 1-3, the primary components of exemplary embodiments of a dispenser apparatus 100 for producing and/or dispensing a comestible product is shown. Beginning with FIG. 1, the dispenser apparatus 100 may be coupled with a base 20 and tray 30. The base 20 provides support for the dispenser apparatus 100, and the tray 30 serves to catch any dispensed comestible product that is not received in the user's desired receptacle.

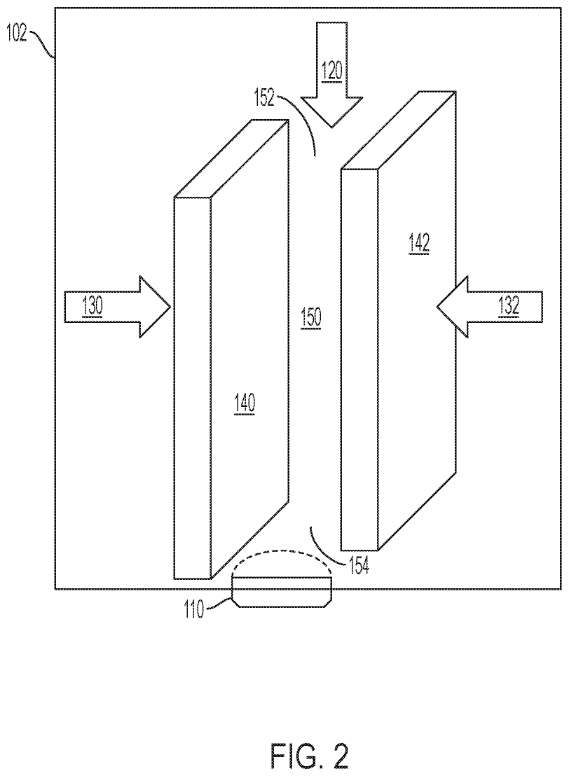

Turning to FIG. 2, the primary components of dispenser apparatus 100 can be seen. As depicted, the dispenser apparatus 100 may include a cooling chamber 102. The interior of the cooling chamber 102 is generally operable to achieve a suitable temperature for dispensing of the comestible product introduced therein. The cooling chamber 102 may also be operable to achieve a suitable temperature for storage of the comestible product when the dispensing apparatus is operated in “continuous” mode. However, it is more preferable that the dispensing apparatus be operated in “batch” mode, where the comestible product is pre-packaged, shelf-stable, and/or a single serving of product, and the cooling chamber is operated to rapidly achieve the temperatures disclosed herein only after introduction of the comestible product therein. For example, the cooling chamber 102 may include or be defined by one or more thermoelectric cooling elements 140, 142. The thermoelectric cooling elements may also be referred to as Peltier effect elements, which may be broadly described as elements that product temperature differentials via metals having difference electrical resistances or conductivities. More specifically, Peltier effect elements are generally small solid-state devices that effectively function as small heat pumps, often in the form of ceramic plates with an array of small semiconductor couples electrically connected in series and thermally connected in parallel sandwiched between the ceramic plates. When a DC current is applied, heat is moved from one side of the element to the other, where it is removed by heat dissipation means (e.g., a heat sink).

The comestible product can be introduced directly into the cooling chamber (e.g., by pouring the comestible product into the cooling chamber). Alternatively, the comestible product may be stored in a container (e.g., a deformable container of the type described in more detail herein), and the container may be introduced into the cooling chamber. When the comestible product is stored in a container that is introduced into the cooling chamber, the need to clean or sanitize the cooling chamber after dispensing is alleviated or eliminated. In this regard, the container may be a single-use disposable container, such as a single-use pod or cartridge. The disposable and enclosed nature of the container may thereby obviate the need to clean or sanitize the cooling chamber after dispensing. The comestible product may be a shelf-stable product and may be stored and introduced into the dispensing apparatus at a temperature of 50 degrees Fahrenheit or more.

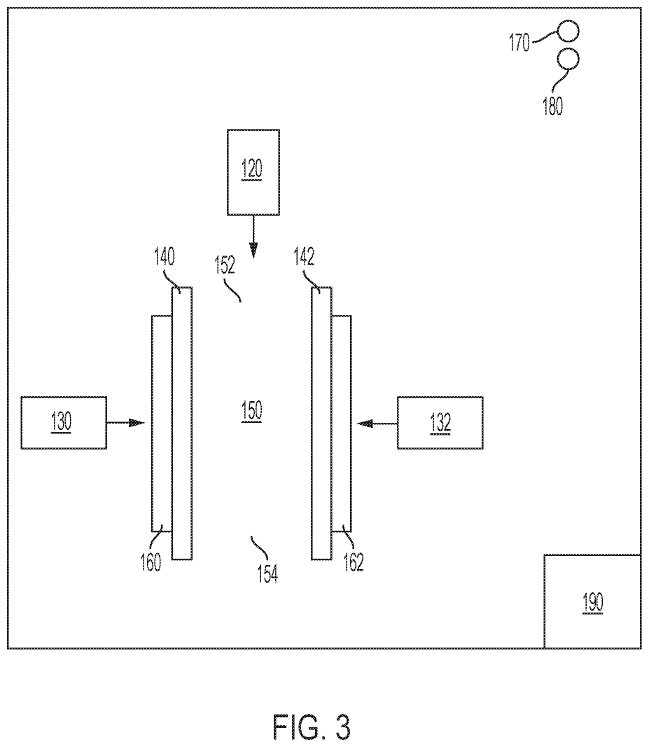

In apparatus 100, the thermoelectric cooling elements generally have a “hot” side and a cold “side.” In FIGS. 2 and 3, the inner surface of each thermoelectric cooling element (i.e., the side facing the product conduit) would be considered the “cold” side, with the opposing outer surfaces being considered the “hot” side. The “cold” side may be in contact with a cold sink and/or the “hot” side may be in contact with a heat sink to enhance the efficiency of the thermoelectric cooling elements. Stacking or clustering of the thermoelectric cooling elements and/or custom forming or shaping of the thermoelectric cooling elements (e.g., with curved faces) can be used to produce a sharper thermal gradient, thereby achieving decreasing cooling time. The thermoelectric cooling elements may generally be of any desired size or shape for the particular application, such as plates having a substantially planar profile. The thermoelectric cooling elements may be from about 1/16 to ¼ inches in thickness and from about one to several inches in width and length.

The thermoelectric cooling elements 140, 142 may be configured to bring the temperature of the cooling chamber 102 to below the freezing point of the comestible product to form a frozen, comestible product. In particular, thermoelectric cooling elements 140, 142 may be configured to bring the temperature of the product conduit 150 to below the freezing point of the comestible product to form a frozen, comestible product. The thermoelectric cooling elements 140, 142 allow for rapid freeze-down times for the comestible product, including freeze-down times that are much quicker than conventional soft serve and frozen beverage machines or batch freezers that require from about 5 to about 15 minutes for typical soft-serve and barrel frozen beverage machines or batch freezers, and over 30 minutes for frozen beverage or granita machines with a plastic bowl. The thermoelectric cooling elements are generally capable of cooling the product to any desired temperature (e.g., to a frozen or semi-frozen state) for effective dispensing of the particular product. In a preferred embodiment, the thermoelectric cooling elements are capable of cooling the comestible product to 24 degrees Fahrenheit or less within 60 seconds of starting the dispensing apparatus. Put another way, through the use of thermoelectric cooling, the dispensing apparatus is capable of cooling a shelf-stable comestible product to 24 degrees Fahrenheit within 60 seconds of introduction of the product to the dispensing apparatus. In other embodiments, such as when the product to be dispensed is a frozen beverage product, the product may be cooled by the one or more thermoelectric cooling elements to a greater temperature depending on factors such as gas, brix, and the like, although the frozen beverage product may generally be cooled to a temperature of 32 degrees Fahrenheit or less within 60 seconds of starting the apparatus. Relatedly, in a preferred embodiment, the thermoelectric cooling elements are capable of cooling the cooling chamber to 0 degrees Fahrenheit or less within 20 seconds of starting the dispensing apparatus.

In certain embodiments, such as that depicted in FIG. 1, the thermoelectric cooling elements 140, 142 are spaced apart from one another so as to form a product conduit 150 therebetween. When two or more thermoelectric cooling elements are to be used, the thermoelectric cooling elements may be of the same thickness, so as to ensure efficiencies in transferring heat to the heat sinks that will be described herein. With reference to FIGS. 2 and 3, product conduit 150 may extend from a first or upper end 152 to a second or terminal end 154. The first or upper end 152 of the product conduit 150 is generally open to the interior of the cooling chamber 102 and adapted to receive the comestible product therethrough. The second or terminal end 154 of the product conduit 150 may be coupled to an environment outside the cooling chamber 102, such as via an outlet or opening 110 fluidly connected to the terminal end 154 of the product conduit 150. When the comestible product is ready to be dispensed, opening 110 may operate as an outlet for dispensing the desired amount of comestible product. The opening 110 may, in certain embodiments, be adapted to hold in place the container or a portion thereof (e.g., a dispensing cap or opening from the container).

When the comestible product has been cooled to a sufficient temperature for dispensing, the comestible product may be dispensed from the dispensing apparatus in a variety of ways. In one an embodiment, a vertical extrusion mechanism 120 may be employed. The vertical extrusion mechanism 120 may be used to effect dispensing of the comestible product through the product conduit 150 from the first or upper end 152 to the second or terminal end 154 thereof. In particular, the vertical extrusion mechanism 120 may be used to effect dispensing of the comestible product to and/or through the outlet or opening 110 at the terminal end 154 of the product conduit 150, the opening 110 thereby operating as an outlet for dispensing the comestible product out of the dispensing apparatus and into a desired receptacle (e.g., a cone, cup, or dish). That is, the vertical extrusion mechanism generally effects linear movement of the comestible product parallel to the longitudinal axis of the product conduit and perpendicular to the movement of the lateral extrusion mechanism. The vertical extrusion mechanism may be configured to engage with the comestible product (or, more preferably, with the container in which the comestible product is stored) and effect dispensing of the comestible product through the product conduit. The vertical extrusion mechanism can be any mechanism suitable for effecting dispensing of the comestible product through the product conduit to the nozzle or outlet at the terminal end of the product conduit, such as a plunger or roller. As will be appreciated by those skilled in the art, any mechanism capable of effecting dispensing (e.g., by pushing, pressing, squeezing, pinching, pressurizing, propelling) of the comestible product from the dispensing apparatus is suitable for use as the vertical extrusion mechanism. Simply put, the vertical extrusion mechanism is configured to compress the comestible product (or, more preferably, the container in which the comestible product is stored), thereby reducing its volume and extruding the comestible product under increased pressure.

As the comestible product is positioned in the product conduit 150 between the thermoelectric cooling elements 140, 142, the thermoelectric cooling elements may be moved toward and away from the product conduit 150 so as to selectively control the amount of cooling. For example, example, one or more lateral extrusion mechanisms 130, 132 can be employed for effecting linear movement of the thermoelectric cooling elements 140, 142 toward and away from the product conduit 150. In this way, the comestible product in the product conduit 150 can be selectively cooled by effecting movement of the thermoelectric cooling elements toward the product conduit (and, in this embodiment, toward one another) using the corresponding. In certain embodiments, the product or, more preferably, its container may include a tag, RFID chip, or similar device containing data readable by the dispensing apparatus that carriers certain information about the product, such as the desired dispensing temperature, and/or desired freeze-down time. In response to reading such data, the dispensing apparatus may selectively control activation of the various components to achieve the desired dispensing parameters, such as controlling activation and/or movement of the thermoelectric cooling elements, the extrusion mechanism(s), or other components of the apparatus. In preferred embodiments, the lateral extrusion mechanisms are operated so that the product conduit and/or the deformable container in which the comestible product is stored receives maximum surface area exposure to the thermoelectric cooling elements. Alternatively, or in addition to, the vertical extrusion mechanisms, the lateral extrusion mechanisms may be used to effect dispensing of the comestible product from the product conduit. For example, the lateral extrusion mechanism may push, press, or otherwise effect movement of the thermoelectric cooling elements toward the product conduit, thereby reducing the volume of the product conduit and/or the deformable container in which the comestible product is stored and effecting dispensing of the comestible product under increased pressure.

In this exemplary embodiment, movement of each thermoelectric cooling element is effected by its own corresponding lateral extrusion mechanism. Notwithstanding, as will be appreciated by those skilled in the art, any number or combination of thermoelectric cooling elements and lateral extrusion mechanisms may be employed. For example, it is specifically contemplated that a single thermoelectric cooling element could be employed opposite a stationary wall of the cooling chamber, with movement of the thermoelectric cooling element capable toward and away from the product conduit positioned between the stationary wall and movable thermoelectric cooling element. For example, if, in such embodiment, it is desired to use the lateral extrusion mechanism for effecting dispensing of the comestible product, the lateral extrusion mechanism may be operated to cause the thermoelectric cooling elements to push or press against the product conduit (with the stationary wall acting as a pressing force along the other side of the product conduit), thereby reducing the volume of the product conduit and/or the deformable container in which the comestible product is stored and effecting dispensing of the comestible product under increased pressure. That is, the lateral extrusion mechanism generally effects linear movement of the thermoelectric cooling element perpendicular to its face plane and parallel to the longitudinal axis of the product conduit. The lateral extrusion mechanisms can be any mechanism suitable for effecting movement a thermoelectric cooling element toward and away from the product conduit, such as a spring or plunger. As will be appreciated by those skilled in the art, any mechanism capable of effecting movement (e.g., by pushing, pressing) of the thermoelectric cooling element toward and away from the product conduit is suitable for use as the vertical extrusion mechanism. Similar to the vertical extrusion mechanism, the lateral extrusion mechanism may be configured to contact and effect movement of the thermoelectric cooling plate, such that the thermoelectric cooling plate contacts and compresses the comestible product (or, more preferably, the container in which the comestible product is stored), thereby reducing its volume and extruding the comestible product under increased pressure.

A series of valves (not depicted) may also be included within the cooling chamber. For example, a terminal valve may be included at the terminal end 154 of the product conduit 150. The terminal valve may, alone or in combination with the vertical or lateral extrusion mechanisms, be used to selectively control dispensing of the comestible product, such as the amount of the comestible product that is dispensed or, in the case of a multi-way valve and multiple comestible products, which comestible product is dispensed.

With reference now to FIG. 3, the dispensing apparatus may also include one or more heat sinks 160, 162. As depicted in FIG. 3, a heat sink may be provided on the back side of each thermoelectric cooling element, such that each thermoelectric cooling element is positioned between a heat sink and the product conduit. In this way, each thermoelectric cooling element may include an inner surface that generally faces the product conduit and an opposing outer surface in contact with a heat sink. The heat sinks of the present disclosure may be any heat dissipation means, such as a metal element (e.g., of aluminum or copper) including a series of vanes or fins over which may flow a current of cooling air produced by, for example, a motor-driven fan. Alternatively, or in addition to the use of heat sinks, the thermoelectric cooling elements may be water and/or liquid cooled. A circulation fan 180 and/or temperature controls 190 may also be included for selectively regulating the temperature inside the cooling chamber.

In some examples, the comestible product may be a soft serve ice cream mixture or frozen yogurt liquid mixture. The freezable, comestible liquid mixture may be in concentrated form and diluted with water from a water input 170 or may be present ready-to-use when introduced to product conduit 150. Water input 170 may be fluidly coupled to product conduit 150. In this scenario, water from water input 170 may dilute the comestible liquid mixture in a controlled fashion, and water input 170 may include a solenoid valve to accomplish this dilution. The dispensing apparatus may further include an air or gas inlet (not shown) to mix in and create a higher overrun.

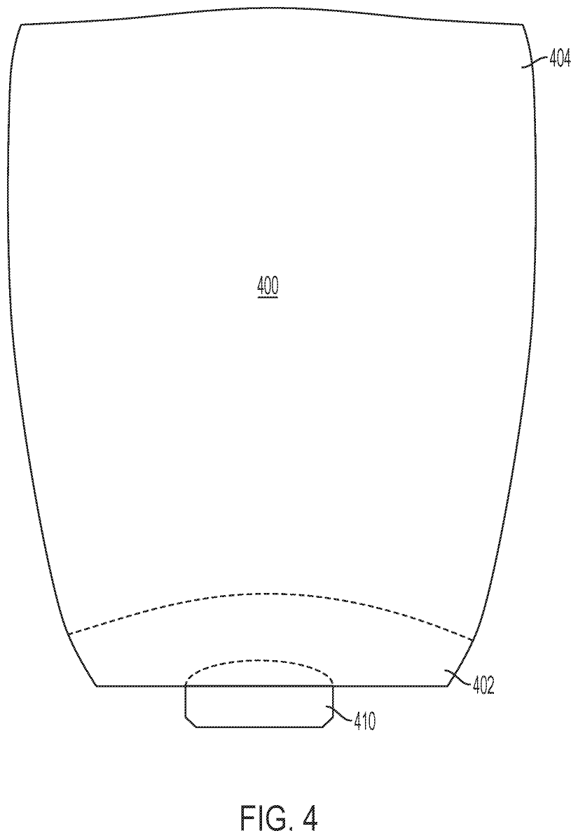

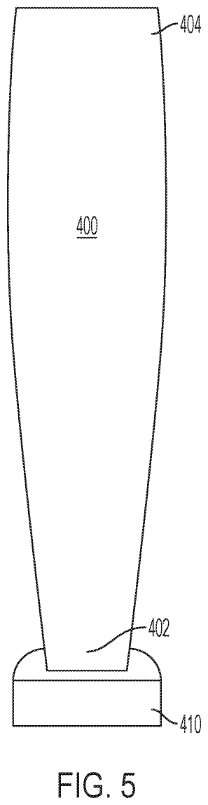

In other examples, the comestible product may be a shelf-stable product that is “ready-to-serve,” needing only to be cooled prior to dispensing or cooled and removed for consumption. As depicted in FIGS. 4 and 5, such comestible product may be present in a deformable container 400. The exemplary deformable container depicted in FIGS. 4 and 5 includes a first or upper end 404 and a second or terminal end 402. The deformable container 400 may include a nozzle or outlet 410 at the terminal end thereof. The outlet 410 may be configured to cooperatively engage with the outlet or opening 110 of the cooling chamber. In this way, the comestible product may be cooled within the deformable container by the thermoelectric cooling elements. The comestible product may subsequently be extruded from the deformable container through the outlet thereof and through the nozzle or outlet of the cooling chamber, thereby dispensing the comestible product from the dispensing apparatus into the user's desired receptacle. In alternative embodiments, the deformable container may be designed such that a user may consume the comestible product directly therefrom after cooling of the product, such as through an opening in the pouch adapted to receive a straw therethrough or, alternatively, through an opening through which the user may squeeze or otherwise extrude the product by hand. The deformable container may be made of any deformable material, such as a polymeric or polyethylene material. Other suitable materials for the deformable container include, for example, aluminum, acrylic, cotton, nylon, leather, rubber, polyvinylchloride, glass, ceramic, silicone. The deformable container may generally be in any desired shape, such as in the shape of a bag, pouch, tube, or sleeve. The deformable container may also generally have any desired shape, such as being sized to accommodate from about 2 to about 128 ounces of comestible product. Deformable container 400 may be hermetically sealed and/or aseptically sealed before coupling with product conduit 150 and may prevent the comestible product from becoming contaminated and/or spoiling when stored or transported over an extended period of time. For instance, in some examples, the shelf life of the comestible product when stored in deformable container 400 may be from about 6 months to about 2 years and beyond.

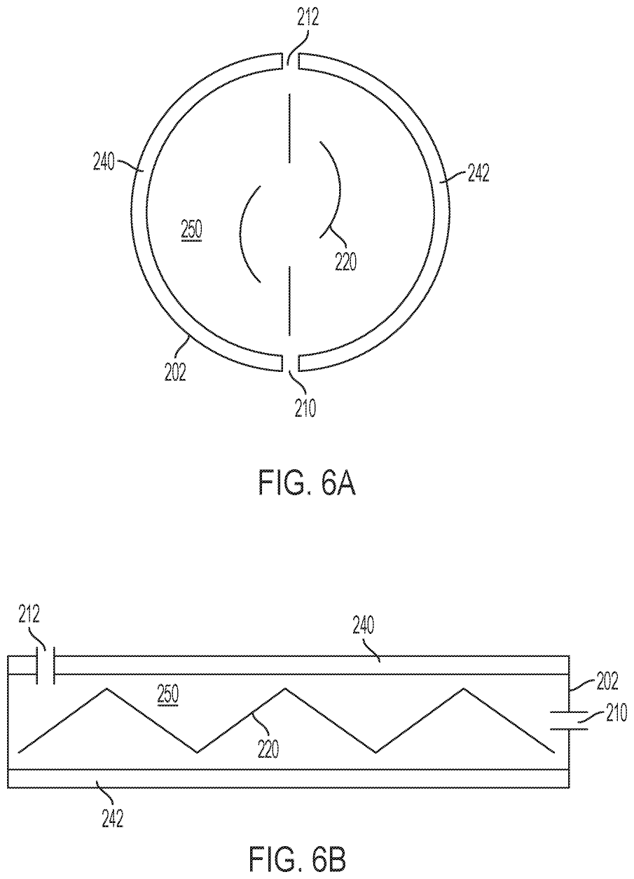

With reference to FIGS. 6A and 6B, which depict alternative embodiments, the thermoelectric cooling elements 240, 242 may have a generally semicircular cross-section. In this way, the thermoelectric cooling elements may define or form a generally circular product conduit 250 therebetween. For example, the product conduit may have a generally spherical cross-section (as in FIG. 6A) or may have a generally cylindrical cross-section (as in FIG. 6B). An inlet 212 and/or an outlet 210 may be positioned between the thermoelectric cooling elements. In addition, as depicted in FIG. 6B, the inlet and outlet can generally be positioned at opposite ends of the product conduit 250.

With continued reference to FIGS. 6A and 6B, the cooling chamber 202 may be provided with an agitator 220 driven by a motor (not depicted) and may mix and stir a freezable, comestible liquid mixture, a frozen product, and/or a combination thereof within the cooling chamber 202. The motor and the agitator 220 may be selected to be capable of mixing and stirring a viscous freezable, comestible liquid mixture. In some embodiments, the walls of the cooling chamber 202 may become cooled and frozen product may become frozen to the walls of the cooling chamber. The agitator 220 may scrape frozen product off the wall and remix the frozen product with the freezable, comestible liquid mixture. This process may be repeated through the freeze chamber 202 until, eventually, all the freezable, comestible liquid mixture is frozen into frozen product. Accordingly, the frozen product, which in some examples is a soft serve ice cream or frozen yogurt product, is dispensed at a temperature of 24 degrees Fahrenheit or less. In an alternate embodiment, the agitator 220 may also be cooled by the thermoelectric cooling elements.

In the alternative embodiment depicted in FIGS. 6A and 6B, the comestible product may be introduced directly into the cooling chamber (e.g., by pouring the comestible product directly into the cooling chamber). Put another way, in the alternative embodiment depicted in FIGS. 6A and 6B, the comestible product may not be stored in a deformable container.

Some differences between the dispenser apparatus and methods described herein and conventional frozen products will be described. The use of thermoelectric cooling elements has the advantages of avoiding the use of some moving parts; avoiding the use of compressors, condensers, and refrigerant and refrigerant lines, which cannot be moved and are commonly susceptible to leaking, corrosion, and cracking and which require highly skilled and certified refrigeration technicians for fixing; increased life; and decreased size, noise, vibration, cost, and required cleaning. Unlike conventional systems, the disclosed dispenser apparatus requires minimal to no routine cleaning or sanitation. Further, the disclosed dispenser apparatus is much smaller and less expensive than conventional systems. For example, the disclosed dispenser apparatus may weigh about 35 pounds or less (including a total weight of 10 pounds or less) and/or have a volume of about 2-3 cubic feet or less (including a total volume of less than 1 cubic foot), which is about 1/10 the size or less of a conventional system. While manufacturing costs for conventional soft serve and frozen beverage machines or batch freezers typically begin at $1,500 and can be considerably greater, the manufacturing costs for the disclosed dispensing apparatus can be $75 or less. The disclosed dispenser apparatus is further capable of rapid freeze-down times of pre-made, shelf-stable products. For example, the disclosed dispenser apparatus may be capable of freeze-down times of from about 30-60 seconds or less, in comparison to conventional systems having freeze-down times of from about 5 to about 15 minutes. In addition, the disclosed dispenser apparatus may be capable of receiving shelf-stable product (e.g., stored and introduced at a temperature of 50 degrees Fahrenheit or more) and cool such product to a suitable dispensing temperature (e.g., to 24 degrees Fahrenheit or less) in less than 60 seconds, whereas conventional systems are only capable of cooling such shelf-stable product to a suitable dispensing temperature in over 5 minutes. The disclosed dispensing apparatus thus obviates the need to transport and store product at low temperatures, thereby reducing transport and storage costs. As a result of the rapid freeze-down times achievable, the disclosed dispensing apparatus may be operable in a non-continuous “batch” mode, which requires the apparatus to only be running when product is desired to be dispensed. In comparison, conventional machines or freezers must typically be operated in continuous “on demand” modes, which requires the system to be constantly running and results in undesirable inefficiencies. The disclosed dispenser apparatus does not require many of the bulky and expensive components required by conventional systems, such as compressors, condensers, refrigerant lines, or refrigerants such as Freon. The disclosed dispensing apparatus may also be devoid of any augers, beater, or blades as will typically be found in conventional machines or freezers. The disclosed dispensing apparatus may likewise be devoid of any O-rings, gaskets, or other seals as will typically be found in conventional machines or freezers. Finally, the disclosed dispenser may have a significantly lower heat output and/or electrical consumption than conventional machines or freezers.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. An apparatus for dispensing a comestible product, the apparatus comprising:
a cooling chamber, wherein the cooling chamber is adapted to receive a deformable container within which the comestible product is stored;
a product conduit having an upper end and a terminal end;
at least one thermoelectric cooling element; and
an extrusion mechanism configured to effect dispensing of the comestible through the product conduit to an outlet at the terminal end of the product conduit.

2. The apparatus of claim 1, further comprising a heat sink, wherein the at least one thermoelectric cooling element is positioned between the heat sink and the product conduit.

3. The apparatus of claim 1, wherein the at least one thermoelectric cooling element includes a first thermoelectric cooling element and a second thermoelectric cooling element, the first and second thermoelectric cooling elements being spaced apart from one another so as to form the product conduit therebetween.

4. The apparatus of claim 3, further comprising a first heat sink and a second heat sink, wherein the first thermoelectric cooling element is positioned between the first heat sink and the product conduit and the second thermoelectric cooling element is positioned between the second heat sink and the product conduit.

5. The apparatus of claim 1, wherein the extrusion mechanism is a lateral extrusion mechanism configured to contact and effect movement of the at least one thermoelectric cooling element toward and away from the product conduit, such that the thermoelectric cooling contacts and at least partially compresses the deformable container, thereby reducing the volume of the deformable container and extruding the comestible product under increased pressure through the product conduit to an outlet at the terminal end of the product conduit.

6. The apparatus of claim 5, wherein the lateral extrusion mechanism is a spring or plunger.

7. The apparatus of claim 1, wherein the extrusion mechanism is a vertical extrusion mechanism configured to at least partially compress the deformable container, thereby reducing the volume of the deformable container and extruding the comestible product under increased pressure through the product conduit to an outlet at the terminal end of the product conduit.

8. The apparatus of claim 7, wherein the vertical extrusion mechanism is a plunger or roller.

9. The apparatus of claim 1, wherein the at least one thermoelectric cooling element is capable of cooling the cooling chamber to 0 degrees Fahrenheit or less within 20 seconds of starting the apparatus, and is further capable of cooling the comestible product to 24 degrees Fahrenheit or less within 60 seconds of starting the apparatus.

10. The apparatus of claim 1, wherein:
the apparatus does not comprise a compressor or condenser; or
the apparatus has a total weight of 35 pounds or less and a total volume of 3 cubic feet or less.

11. The apparatus of claim 1, wherein the deformable container is disposable and contains a single serving of the comestible product.

12. A method for dispensing a comestible product, the method comprising:
introducing a comestible product into a cooler chamber of a dispensing apparatus, the dispensing apparatus comprising at least one thermoelectric cooling element; and
operating an extrusion mechanism of the dispensing apparatus to effect dispensing of the comestible product through the product conduit to an outlet at a terminal end of the product conduit.

13. The method of claim 12, wherein the comestible product is stored within a deformable container.

14. The method of claim 12, wherein operating the extrusion mechanism comprises operating a lateral extrusion mechanism to contact and effect movement of the at least one thermoelectric cooling element toward and away from the product conduit, such that the thermoelectric cooling contacts and at least partially compresses the deformable container, thereby reducing the volume of the deformable container and extruding the comestible product under increased pressure through the product conduit to an outlet at the terminal end of the product conduit.

15. The apparatus of claim 12, wherein operating the extrusion mechanism comprises operating a vertical extrusion mechanism to at least partially compress the deformable container, thereby reducing the volume of the deformable container and extruding the comestible product under increased pressure through the product conduit to an outlet at the terminal end of the product conduit.

16. The method of claim 12, wherein the at least one thermoelectric cooling element cools the cooling chamber to 0 degrees Fahrenheit or less within 20 seconds of starting the apparatus, and is further capable of cooling the comestible product to 24 degrees Fahrenheit or less within 60 seconds of starting the dispensing apparatus.

17. The method of claim 16, wherein the comestible product is at a temperature of 50 degrees Fahrenheit or more prior to the introducing step.

18. An apparatus for dispensing a comestible product, the apparatus comprising:
a cooling chamber, wherein the cooling chamber is adapted to receive a deformable container within which the comestible product is stored; and
at least one thermoelectric cooling element located in the cooling chamber, wherein the at least one thermoelectric cooling element is capable of cooling the cooling chamber to 0 degrees Fahrenheit or less within 20 seconds of starting the apparatus, and is further capable of cooling the comestible product to 24 degrees Fahrenheit or less within 60 seconds of starting the apparatus.

19. The apparatus of claim 18, wherein the at least one thermoelectric cooling element includes first and second thermoelectric cooling elements spaced apart from one another, each of the first and second thermoelectric cooling elements having a semicircular cross-section so as to form a circular product conduit therebetween.

20. The apparatus of claim 19, further comprising an agitator disposed within the product conduit between the first and second thermoelectric cooling elements for mixing the comestible product in the cooling chamber.
